(19) United States
(12) Patent Application Publication
(10) Pub. No.: US 2014/0057237 A1
(43) Pub. Date: Feb. 27, 2014

(54) METHOD FOR PARKING A VEHICLE BY USING A PARKING ASSISTANT SYSTEM

(71) Applicant: Stephen CHEN, Changhua (TW)

(72) Inventor: Stephen CHEN, Changhua (TW)

(21) Appl. No.: 13/594,870

(22) Filed: Aug. 27, 2012

(51) Int. Cl. G09B 19/14

(52) U.S. Cl. 434/305

(57) ABSTRACT

A method for parking a vehicle enables a driver to park a vehicle easily and quickly by using a parking assistant system. Based on the distance from the vehicle to an adjacent vehicle detected or calculated by the parking assistant system, and the virtual parking path calculated based on the virtual parking position selected by the target parking frame and the specification of the vehicle, the only thing that the driver needs to do during parking, simply involves turning the steering wheel to the extreme left, right and to the center, and driving the vehicle forward and backward, therefore, the parking operation is very simple and easy.

### BACKGROUND OF THE INVENTION

1. Field of the Invention

The present invention relates to parts of a vehicle, and more particularly to a method for parking a vehicle by using a parking assistant system.

2. Description of the Prior Art

Reverse parking is one of the relatively difficult driving activities during driving, therefore, various parking assistant systems appeared on the market. One of the popular parking assistant systems is usually provided with parking sensors to detect the obstacles behind the host vehicle so as to prevent scratching. Or, cameras are disposed on the rear of the vehicle to take images of the area behind the vehicle, the images taken by the cameras are displayed on the display unit inside the vehicle for allowing the driver to view the condition behind the vehicle during reverse parking. On the display unit is designed a target parking frame which is to be aligned with the parking space. The parking assistant system just assists the driver in parking without providing further help.

Some of the luxury vehicles are equipped with an automatic parking system which uses ultrasonic to measure the parking space, the vehicle with the automatic parking system can be parked automatically by the vehicle itself, the only thing that the driver needs to do, during parking, is to step on the brake. In other words, the control of the vehicle completely relies on the automatic parking system, which will also increase the possibility of error operation since the real driving environment is usually ignored. Furthermore, to possess the automatic parking function, the automatic parking system inevitably has a complicated structural and therefore is relatively expensive.

The present invention has arisen to mitigate and/or obviate the afore-described disadvantages.

### SUMMARY OF THE INVENTION

The primary object of the present invention is to provide a method for assisting a driver to park a vehicle easily and quickly by using a parking assistant system.

To achieve the above object, a method for parking a vehicle by using a parking assistant system is provided in accordance with the present invention, the parking assistant system comprises a lateral camera, a displacement-detecting unit, a display unit built-in with a parking-path planning software, and a CPU, the method for parking a vehicle by using the parking assistant system comprises the following steps:

turning on the parking assistant system;

the display unit displaying the images of the lateral areas of the vehicle taken by the lateral camera and displaying a movable target parking frame which is to be moved to a virtual parking position where the vehicle is to be parked by a driver;

the CPU calculating a virtual parking path based on the virtual parking position and a specification of the vehicle, and the virtual parking path including a turning point and an end point, the display unit instructing the driver to reverse the vehicle by turning a steering wheel of the vehicle toward a parking space where the vehicle to be parked, and the steering wheel being turned to the extreme;

the displacement-detecting unit detecting an actual path that the vehicle travels and comparing it with the optimum virtual parking path, when the vehicle moves along to the turning point of the virtual parking path, the display unit instructs the driver to turn the steering wheel reversely to the extreme in a direction opposite the direction of the parking space and the driver continues reversing the vehicle; and

the displacement-detecting unit continues detecting the actual path that the vehicle travels and comparing it with the virtual parking path, when the vehicle moves to the end point of the virtual parking path, the parking assistance parking assistant system is turned off.

To achieve the above object, the present invention provides another method for parking a vehicle by using a parking assistant system, the parking assistant system comprising a lateral camera, a displacement-detecting unit, a display unit built-in with a parking-path planning software, and a CPU, the method for parking a vehicle by using the parking assistant system comprises the following steps:

turning on the parking assistant system;

the display unit displaying the images of the lateral areas of the vehicle taken by the lateral camera and also displaying a movable target parking frame and an obstacle frame, the target parking frame is allowed to be moved to a virtual parking position where the vehicle is to be parked by a driver;

using the CPU to calculate a virtual parking path based on the virtual parking position and a specification of the vehicle, and the virtual parking path including a turning point and an end point;

the driver presses down the start key after driving the vehicle to a position where the obstacle is overlapped with wheels of an adjacent vehicle, then the display unit starts to instruct the driver to reverse the vehicle by turning the steering wheel toward the parking space, and the steering wheel is turned to the extreme;

the displacement-detecting unit detecting an actual path that the vehicle travels and comparing it with the optimum virtual parking path, when the vehicle moves along to the turning point of the virtual parking path, the display unit instructs the driver to turn the steering wheel reversely to the extreme in a direction opposite the direction of the parking space and the driver continues reversing the vehicle; and

the displacement-detecting unit continues detecting the actual path that the vehicle travels and comparing it with the virtual parking path, when the vehicle moves to the end point of the virtual parking path, the parking assistance parking assistant system is turned off.

To achieve the above object, yet, the present invention provides another method for parking a vehicle by using a parking assistant system, the parking assistant system comprising: a lateral camera, a displacement-detecting unit, a display unit, a distance-detecting unit, and a CPU built-in with a parking-path planning software, the method for parking a vehicle by using the parking assistant system comprising the following steps:

turning on the parking assistant system;

using the display unit to display the images of the lateral areas of the vehicle taken by the lateral camera, and the distance-detecting unit calculating a distance from the vehicle to an adjacent vehicle;

using the CPU to calculate a virtual parking path based on the distance from the vehicle to the adjacent vehicle calculated by the distance-detecting unit, and a specification of the vehicle, and the virtual parking path including an obstacle frame, a turning point and an end point, and the obstacle frame being displayed on the display unit;

the driver presses down the start key after driving the vehicle to a position where the obstacle is overlapped with wheels of an adjacent vehicle, then the display unit starts to instruct the driver to reverse the vehicle by turning the steering wheel toward the parking space, and the steering wheel is turned to the extreme;

the displacement-detecting unit detecting an actual path that the vehicle travels and comparing it with the optimum virtual parking path, when the vehicle moves along to the turning point of the virtual parking path, the display unit instructs the driver to turn the steering wheel reversely to the extreme in a direction opposite the direction of the parking space and the driver continues reversing the vehicle; and

the displacement-detecting unit continues detecting the actual path that the vehicle a travels and comparing it with the virtual parking path, when the vehicle moves to the end point of the virtual parking path, the parking assistance parking assistant system is turned off.

With the aid of the parking assistant system of the present invention, the operation that the driver is required to do simply includes turning the steering wheel to the extreme left, right and to the center, and driving the vehicle forward and backward, the parking operation is very simple, so that the possibility of error operation can be reduced to the least.

### BRIEF DESCRIPTION OF THE DRAWINGS

FIG. 1 is a flow chart showing a method for parking a vehicle by using a parking assistant system in accordance with a first preferred embodiment of the present invention;

FIG. 2 is an illustrative view showing that the method for parking a vehicle by using a parking assistant system in accordance with the present invention;

FIG. 3 is an illustrative view showing an optimum parking path planned by the parking method in accordance with the present invention;

FIG. 4 is another illustrative view showing that the method for parking a vehicle by using a parking assistant system in accordance with the present invention;

FIG. 5A shows the image displayed on the display unit of the present invention, wherein the target parking frame P has not been moved;

FIG. 5B shows the image displayed on the display unit of the present invention, wherein the target parking frame P has been moved to a desired parking position where the vehicle is to be moved;

FIG. 6 is an illustrative view showing an optimum parking path planned by the parking method in accordance with the present invention;

FIG. 7 is another illustrative view showing an optimum parking path planned by the parking method in accordance with the present invention;

FIG. 8 is another illustrative view showing an optimum parking path planned by the parking method in accordance with the present invention;

FIG. 9A shows the image displayed on the display unit in accordance with another embodiment of the present invention, wherein the target parking frame P has not been moved; and

FIG. 9B shows the image displayed on the display unit in accordance with another embodiment of the present invention, wherein the target parking frame P has been moved to a desired parking position where the vehicle is to be moved.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

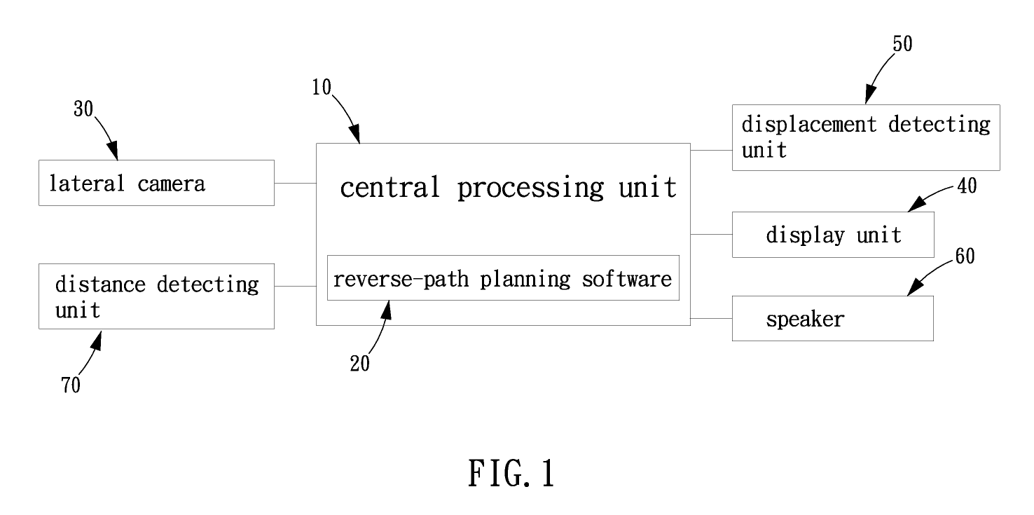

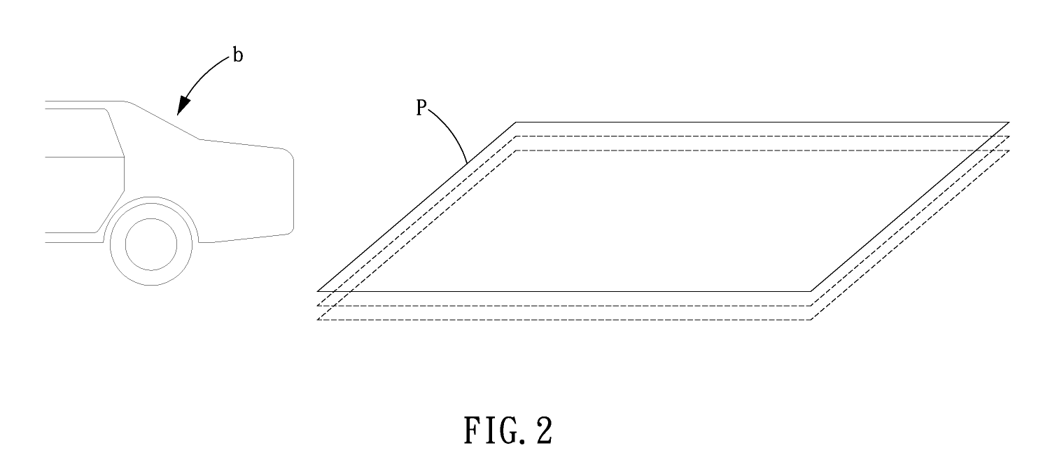

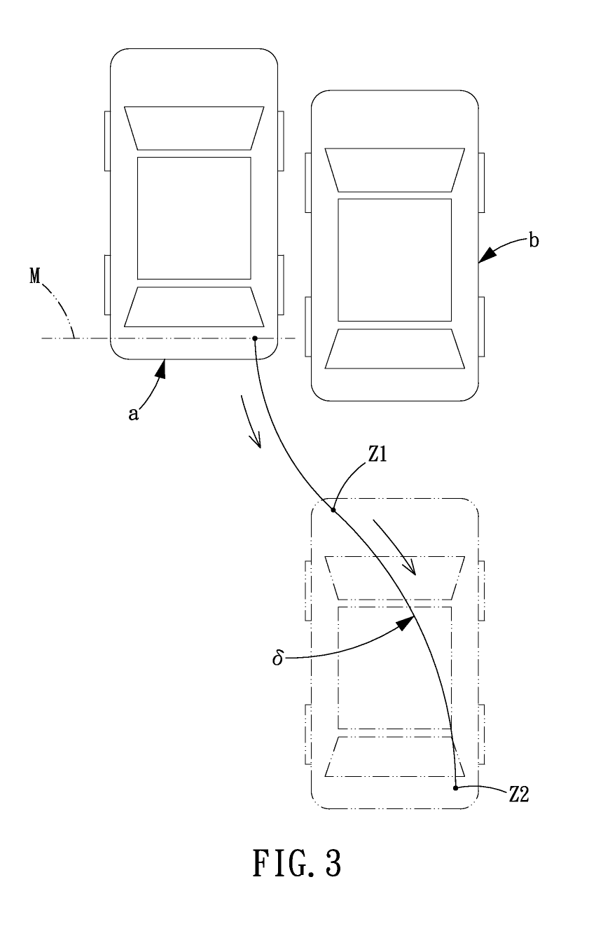

Referring to FIGS. 1, 2, 3 and 9, a method for parking a vehicle by using a parking assistant system in accordance with a first preferred embodiment of the present invention is shown, wherein the parking assistant system comprises: a lateral camera 30, a displacement-detecting unit 50, a display unit 40 built-in with a parking-path planning software 20, and a CPU (central processing unit) 10. The method for parking a vehicle by using the parking assistant system comprises the following steps:

1. turning on the parking assistant system.

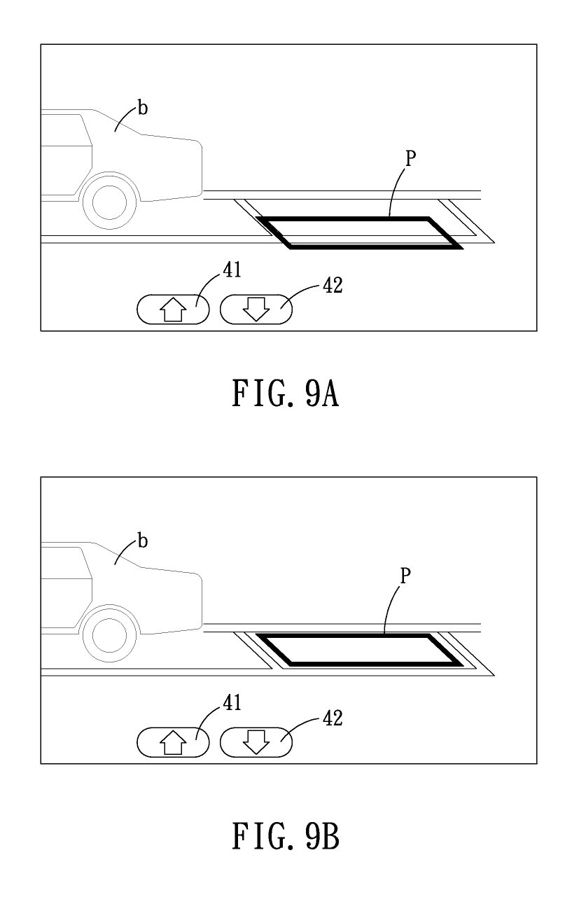

2. using the display unit 40 to display the images of the lateral areas of the vehicle taken by the lateral camera 30, the display unit 40 is further capable of simultaneously displaying a movable target parking frame P which can be moved to a desired virtual parking position where the vehicle is to be parked by the user, and the virtual parking position to which the movable target parking frame P is moved is recorded by the CPU 10; there are a plurality of target parking frames P on the display unit 40, and the driver can choose one of the target parking frames P. As shown in FIG. 9, the target parking frame P can be moved by using an upward key 41 and a downward key 42.

3. using the CPU 10 to calculate an optimum virtual parking path δ based on the virtual parking position selected by the target parking frame P and the specification of the vehicle a, and the virtual parking path includes a turning point Z1 and an end point Z2, meanwhile, the display unit 40 instructs the driver to reverse the vehicle by turning the steering wheel toward the parking space, and the steering wheel is turned to the extreme.

4. when the vehicle a is moving, the displacement-detecting unit 50 detects the actual path that the vehicle a travels and compares it with the optimum virtual parking path δ. When the vehicle a moves along the optimum virtual parking path δ to the turning point Z1, the display unit 40 instructs the driver to turn the steering wheel reversely to the extreme (in a direction opposite the direction of the parking space) and the driver continues reversing the vehicle a. The displacement-detecting unit 50 detects whether the driver moves the vehicle a as guided by the parking assistant system, if the displacement-detecting unit 50 detects that the driver fails to drive the vehicle a as guided by the parking assistant system, the parking assistant system will be turned off, and the parking instruction provided by the parking assistant system will be cancelled immediately.

5. when the vehicle a is moving, the displacement-detecting unit 50 continues detecting the actual path that the vehicle a travels and comparing it with the optimum virtual parking path δ, when the vehicle a is guided to move along the optimum virtual parking path δ to the end point Z2, the parking assistance parking assistant system will be turned off, and the parking instruction provided by the parking assistant system will be finished immediately.

Referring to FIGS. 1, 2, 4 and 5, a method for parking a vehicle by using a parking assistant system in accordance with a second embodiment of the present invention is shown, wherein the parking assistant system comprises: a lateral camera 30, a displacement-detecting unit 50, a display unit 40 built-in with a parking-path planning software 20, and a CPU (central processing unit) 10. The method for parking a vehicle by using the parking assistant system comprises the following steps:

1. turning on the parking assistant system.

2. using the display unit 40 to display the images of the lateral areas of the vehicle taken by the lateral camera 30, the display unit 40 displays a movable target parking frame P and an obstacle frame M. The target parking frame P can be moved to a desired virtual parking position where the vehicle is to be parked by the user, and the virtual parking position to which the movable target parking frame P is moved is recorded by the CPU 10; there are a plurality of target parking frames P on the display unit 40, and the driver can choose one of the target parking frames P. As shown in FIG. 9, the target parking frame P is controlled by using an upward key 41, a downward key 42 and a start key 43. The upward key 41 and the downward key 42 are used to move the target parking frame P, and the start key 43 is used to initiate the parking instruction. The driver will be reminded that the obstacle frame M should not be overlapped with the wheels of an adjacent vehicle, when the driver moves the target parking frame P.

3. using the CPU 10 to calculate an optimum virtual parking path δ based on the virtual parking position selected by the target parking frame P and the specification of the vehicle a, and the virtual parking path includes a turning point Z1 and an end point Z2, meanwhile, the obstacle frame M is displayed on the display unit 40.

4. the driver presses down the start key 43 after driving the vehicle a to a position where the obstacle M is overlapped with the wheels of the adjacent vehicle, then the display unit 40 starts to instruct the driver to reverse the vehicle by turning the steering wheel toward the parking space, and the steering wheel is turned to the extreme.

5. when the vehicle a is moving, the displacement-detecting unit 50 detects the actual path that the vehicle a travels and compares it with the optimum virtual parking path δ. When the vehicle a moves along the optimum virtual parking path δ to the turning point Z1, the display unit 40 instructs the driver to turn the steering wheel reversely to the extreme (in a direction opposite the direction of the parking space) and instructs the driver to continue reversing the vehicle.

6. when the vehicle a is moving, the displacement-detecting unit 50 continues detecting the actual path that the vehicle a travels and comparing it with the optimum virtual parking path δ, when the vehicle a is guided to move along the optimum virtual parking path δ to the end point Z2, the parking assistance parking assistant system will be turned off, and the parking instruction provided by the parking assistant system will be finished immediately.

Referring to FIGS. 1, 2, 4 and 5, a method for parking a vehicle by using a parking assistant system in accordance with a second embodiment of the present invention is shown, wherein the parking assistant system comprises: a lateral camera 30, a displacement-detecting unit 50, a display unit 40, a distance-detecting unit 70, and a CPU (central processing unit) 10 built-in with a parking-path planning software 20. The method for parking a vehicle by using the parking assistant system comprises the following steps:

1. turning on the parking assistant system.

2. using the display unit 40 to display the images of the lateral areas of the vehicle taken by the lateral camera 30, and the distance-detecting unit 70 calculates the distance from the vehicle a to the adjacent vehicle.

3. using the CPU 10 to calculate an optimum virtual parking path δ based on the distance from the vehicle a to the adjacent vehicle calculated by the distance-detecting unit 70, and the specification of the vehicle a, and the virtual parking path includes an obstacle frame M, a turning point Z1 and an end point Z2. The obstacle frame M is displayed on the display unit 40, and a start key 43 is also displayed on the display unit 40 to allow the driver to initiate the parking instruction (performed by the parking assistant system) by pressing the start key 43.

4. the driver presses down the start key 43 after driving the vehicle a to a position where the obstacle M is overlapped with the wheels of the adjacent vehicle, then the display unit 40 starts to instruct the driver to reverse the vehicle by turning the steering wheel toward the parking space, and the steering wheel is turned to the extreme.

5. when the vehicle a is moving, the displacement-detecting unit 50 detects the actual path that the vehicle a travels and compares it with the optimum virtual parking path δ. When the vehicle a moves along the optimum virtual parking path δ to the turning point Z1, the display unit 40 instructs the driver to turn the steering wheel reversely to the extreme (in a direction opposite the direction of the parking space) and instructs the driver to continue reversing the vehicle.

6. when the vehicle a is moving, the displacement-detecting unit 50 continues detecting the actual path that the vehicle a travels and comparing it with the optimum virtual parking path δ, when the vehicle a is guided to move along the optimum virtual parking path δ to the end point Z2, the parking assistance parking assistant system will be turned off, and the parking instruction provided by the parking assistant system will be finished immediately.

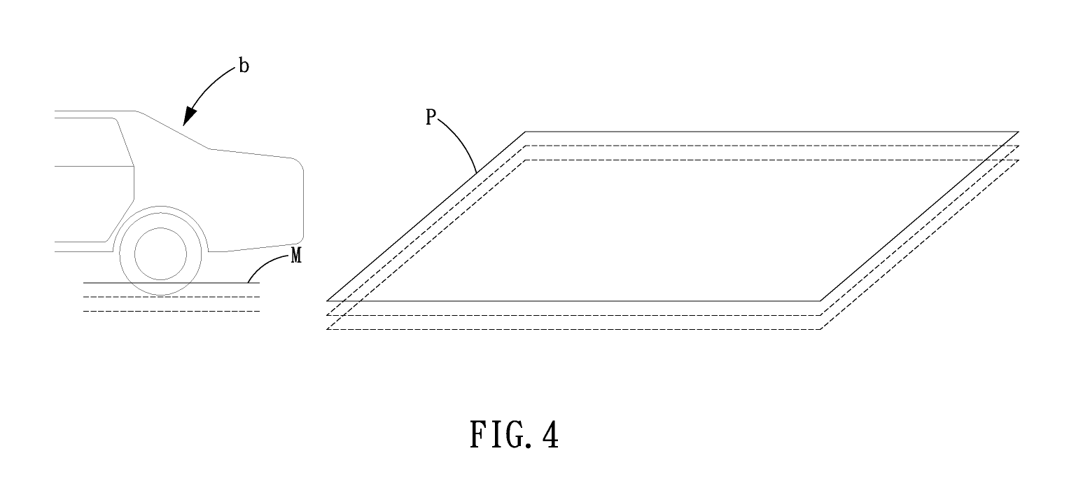

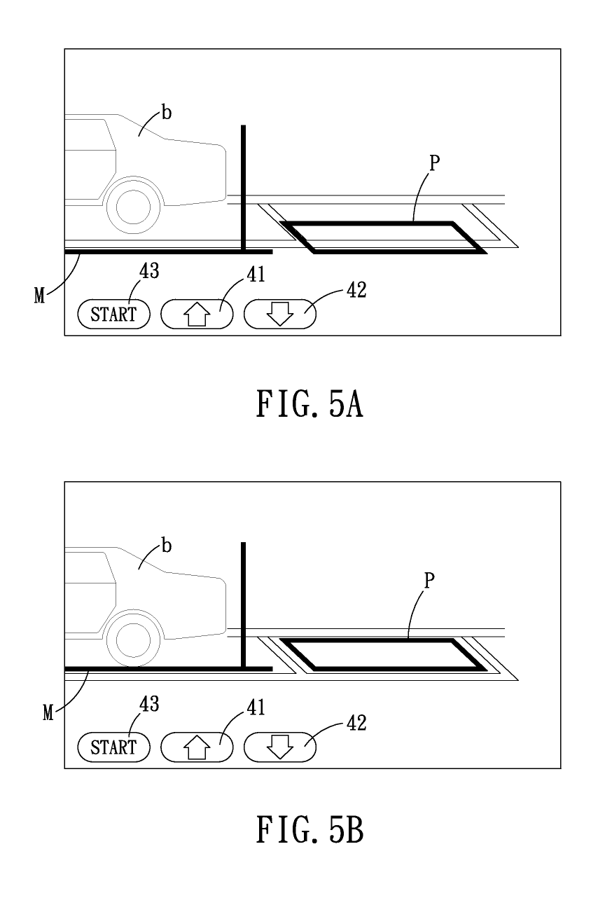

In the step 3, as shown in FIG. 4, the display unit 40 is further capable of simultaneously displaying a movable target parking frame P which can be moved to a desired virtual parking position where the vehicle is to be parked by the driver. The CPU 10 calculates an optimum virtual parking path δ based on the virtual parking position selected by the target parking frame P and the specification of the vehicle a, and the virtual parking path includes an obstacle frame M, a turning point Z1 and an end point Z2. As shown in FIG. 5, the target parking frame P is controlled by using an upward key 41, a downward key 42 and a start key 43. The upward key 41 and the downward key 42 are used to move the target parking frame P, and the start key 43 is used to initiate the parking instruction. The driver will be reminded that the obstacle frame M should not be overlapped with the wheels of an adjacent vehicle, when the driver moves the target parking frame P.

As mentioned above, if the displacement-detecting unit 50 detects that the driver fails to drive the vehicle a along the optimum virtual parking path δ, the parking assistant system will be turned off, and the parking instruction provided by the parking assistant system will be cancelled immediately.

The parking instruction can be images displayed on the display unit 40 to prompt the driver how to park the vehicle, or can be a prompt which uses countdown numbers or lights that go out one by one to prompt the driver. Or, the parking assistant system of the present invention can be provided with a speaker 60 which produces sound or voice to prompt the driver when the displacement-detecting unit 50 detects that the vehicle a moves to the turning point Z1.

The displacement-detecting unit 50 can be a gyroscope or a speed sensor.

When the displacement-detecting unit 50 is a gyroscope, the CPU 10 can calculate the displacement of the vehicle by multiplying the turning angle of the vehicle detected by the gyroscope by the turning radius of the vehicle.

If the displacement-detecting unit 50 is a speed sensor, the CPU 10 calculates the displacement of the vehicle a by multiplying the speed of the vehicle a detected by the speed sensor by the length of time that the vehicle a traveled.

The parking assistant system in accordance with the present invention further includes a steering-wheel-angle detecting unit which is electrically connected to the CPU 10 to detect the rotation angle of the steer wheel by receiving the rotation angle signal from the steer wheel or based on the rotation angle of the vehicle detected by the gyroscope and the speed of the vehicle. If no speed of the vehicle is detected, an acceleration sensor can also be used in combination with the gyroscope to detect the rotation angle of the steering wheel.

The steering-wheel-angle detecting unit also serves to detect whether the driver turns the steering wheel to the center, or to the extreme left or right. When the steering-wheel-angle detecting unit detects that the driver fails to turn the steering wheel or drive the vehicle to the direction as guided, the parking instruction is cancelled immediately.

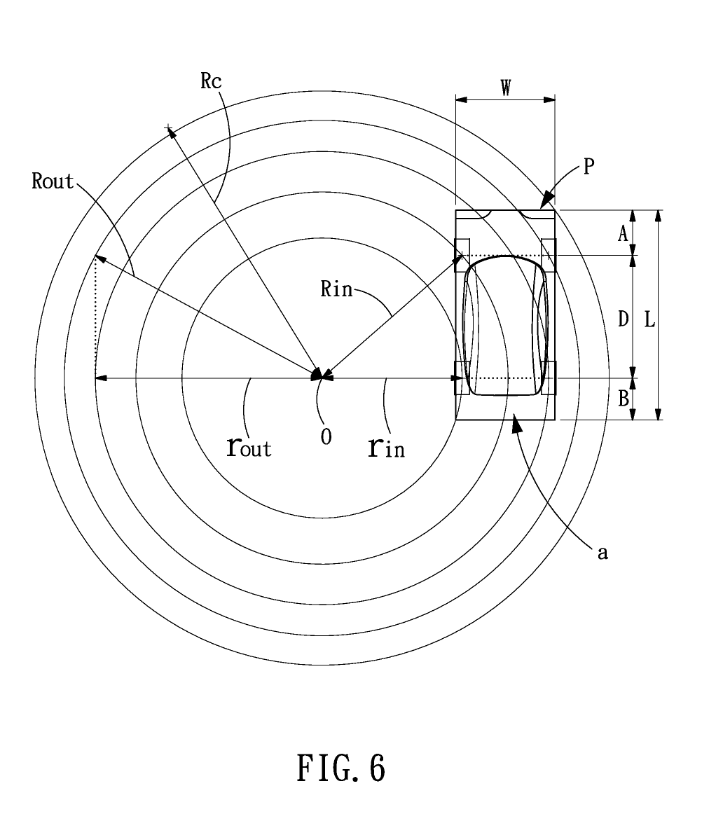

Referring to FIG. 6, which shows a turning path of the host vehicle a, no matter the steering wheel is turned to the extreme right or left, the turning path of the vehicle is the same, hence, based on this characteristic, the present invention designs an optimum virtual parking path δ.

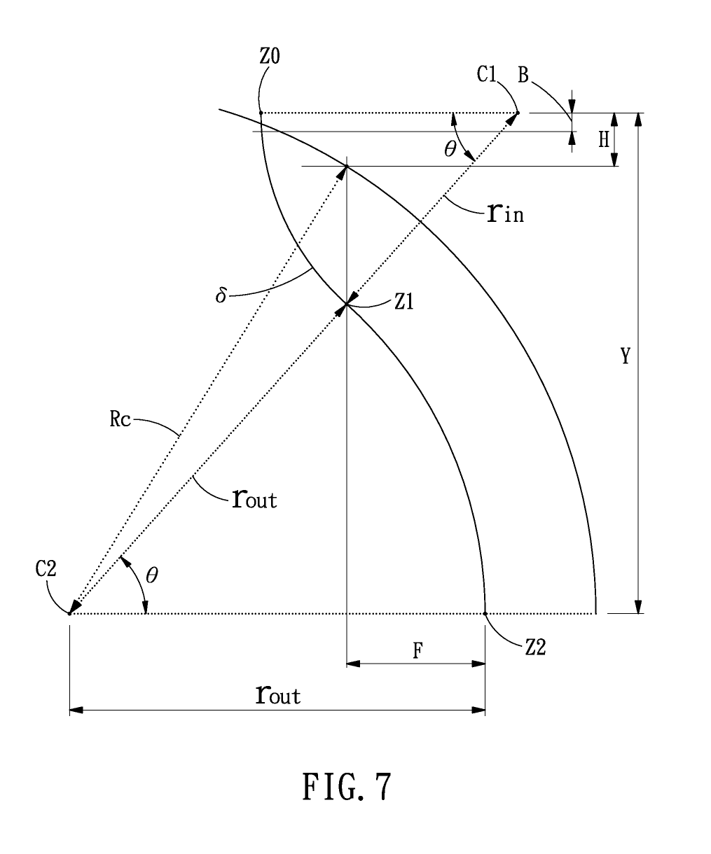

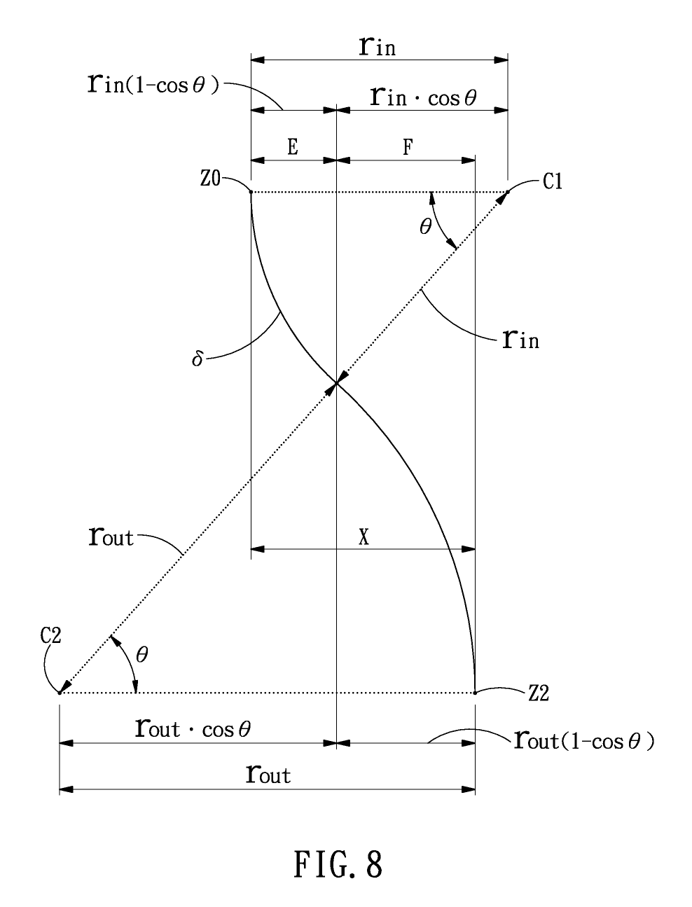

FIGS. 7 and 8 show the radiuses of the turning paths of the respective wheels and the front outer corner of the vehicle, and the specification of the vehicle is defined as follows:

W: represents the width of the vehicle a.

A: the distance front the axis of the front wheels to the front edge of the vehicle a.

B: the distance front the axis of the rear wheels to the rear edge of the vehicle a.

C: the sum of the width of the wheels of the vehicle P and the thickness of the body of the vehicle a that protrudes out of the wheels.

D: the wheelbase between the front and rear axles of the vehicle a.

L: the length of the vehicle a.

The radiuses of the turning paths of the respective wheels and the front outer corner of the vehicle are calculated based on the specification of the vehicle a, and the radiuses are defined as follows:

Rout: the radius of the turning path of the front outer wheel of the vehicle a;

Rin: the radius of the turning path of the front inner wheel of the vehicle a;

rout: the radius of the turning path of the rear outer wheel of the vehicle a;

rin: the radius of the turning path of the rear inner wheel of the vehicle a;

Rc: the radius of the turning path of the front outer corner of the vehicle a;

The method for calculating the turning radius of the vehicle a is explained as follows:

The minimum turning radius of the vehicle a is the turning path of the front outer wheel when the steering wheel is turned to the extreme, therefore, Rout=the minimum turning radius of the vehicle.

Rin is hypotenuse, rin is an adjacent side, and D is an opposite side, according to the trigonometric function, Rin=\sqrt{rin²+D²}.

rout is an adjacent side, Rout is hypotenuse, and D is an opposite side, according to the trigonometric function, rout=\sqrt{Rout²−D²}.

rin=rout−W, however, the wheels have width, the axles of the wheels will be recessed and the body of the vehicle will be projected outward, hence, it requires correction, and the correction amount is C. Therefore, rin=rout−W+C.

Rin is hypotenuse, and D+A is an opposite side, according to the trigonometric function, Rc=\sqrt{rout²+(D+A)²}

Referring to FIG. 8, which shows the virtual parking path δ of the vehicle a, wherein:

E: represents the distance of the vehicle a to a adjacent vehicle.

F: the sum of the width of the vehicle a and a safety allowance.

X: a horizontal distance that the vehicle a is required to travel horizontally to the parking space.

Y: a perpendicular distance that the vehicle is required to travel perpendicularly to the parking space.

θ: a turning angle of the vehicle a at the turning point of the virtual parking path.

c1: represents the center of a first turning path, wherein the first path of the rear right wheel is δ1, and the radius is rin.

c2: represents the center of a second turning path, wherein the second path of the rear right wheel is δ2, and the radius is rout.

The method for calculating the virtual parking path, turning point and end point is explained as follows:

It is apparent from FIG. 8 that the horizontal distance that the vehicle a is required to travel horizontally to the parking space is: X=E+F=X1+X2.

X1=rin(1−cos θ)

X2=rout(1−cos θ)

X=X1+X2=rin(1−cos θ)+rout(1−cos θ)=(rout+rin)(1−cos θ);

It is apparent from FIG. 7 that (rin+rout) is hypotenuse, and Y is an opposite side, according to the trigonometric function, Y=(rin+rout)sin θ.

$$X = ( rout + rin ) ( 1 - cos θ ) ;$$

$$1 - cos θ = \frac{X}{rout + rin} ;$$

$$cos θ = 1 - \frac{X}{rout + rin} ;$$

$$θ = {cos}^{- 1} ( 1 - \frac{X}{rout + rin} ) ;$$

The turning angle θ varies with the change of the horizontal distance, when the horizontal distance is fixed, the turning angle θ can be calculated based on the above equations, and consequently, the virtual parking path δ, the turning point Z1 and end point Z2 of the virtual parking path δ can also be calculated and fixed.

Referring to FIGS. 6-8, a method for calculating the obstacle line of the virtual parking path is explained as follows:

B is the distance from the front the axis of the rear wheels to the rear edge of the vehicle a, F is the sum of the width of the vehicle P and a safety allowance (10-15 cm), Rc is the radius of the turning path of the front outer corner of the vehicle a, S is defined as a distance from a point of intersection between the radius Rc of the turning path of the front outer corner of the vehicle a and the body of the vehicle a to the rear edge of a adjacent vehicle, and rout is the radius of the turning path of the rear outer wheel of the vehicle a the radius of the turning path of the rear outer wheel of the vehicle a.

(rout−F) is a adjacent side, Rc is a hypotenuse, (Y−B−S) is an opposite side, according to the trigonometric function;

Rc²=(Y−B−S)²+(rout−F)²;

(Y−B−S)=\sqrt{Rc²−(rout−F)²};

S=Y−\sqrt{Rc²−(rout−F)²}−B;

S is also the distance the host vehicle a travels forward, according to the calculated virtual parking path, the head of the host vehicle a will just scratch the rear edge of the adjacent vehicle when rotating. To prevent scratch, the calculated S should be deducted by 5-10 cm.

It is known from the above description that, with the aid of the parking assistant system of the present invention, the operation that the driver is required to do simply includes turning the steering wheel to the extreme left, right and to the center, and driving the vehicle forward and backward, the parking operation is very simple, so that the possibility of error operation can be reduced to the least.

While we have shown and described various embodiments in accordance with the present invention, it is clear to those skilled in the art that further embodiments may be made without departing from the scope of the present invention.

What is claimed is:

1. A method for parking a vehicle by using a parking assistant system, the parking assistant system comprising a lateral camera, a displacement-detecting unit, a display unit built-in with a parking-path planning software, and a CPU, the method for parking a vehicle by using the parking assistant system comprising the following steps:
turning on the parking assistant system;
the display unit displaying the images of the lateral areas of the vehicle taken by the lateral camera and displaying a movable target parking frame which is to be moved to a virtual parking position where the vehicle is to be parked by a driver;
the CPU calculating a virtual parking path based on the virtual parking position and a specification of the vehicle, and the virtual parking path including a turning point and an end point, the display unit instructing the driver to reverse the vehicle by turning a steering wheel of the vehicle toward a parking space where the vehicle to be parked, and the steering wheel being turned to the extreme;
the displacement-detecting unit detecting an actual path that the vehicle travels and comparing it with the optimum virtual parking path, when the vehicle moves along to the turning point of the virtual parking path, the display unit instructs the driver to turn the steering wheel reversely to the extreme in a direction opposite the direction of the parking space and the driver continues reversing the vehicle; and
the displacement-detecting unit continues detecting the actual path that the vehicle travels and comparing it with the virtual parking path, when the vehicle moves to the end point of the virtual parking path, the parking assistance parking assistant system is turned off.

2. The method for parking a vehicle by using a parking assistant system as claimed in claim 1, wherein the displacement-detecting unit detects whether the driver moves the vehicle as guided by the parking assistant system, if the displacement-detecting unit detects that the driver fails to drive the vehicle as guided by the parking assistant system, the parking assistant system will be turned off, and parking instruction provided by the parking assistant system will be cancelled immediately.

3. The method for parking a vehicle by using a parking assistant system as claimed in claim 1, wherein the parking assistant system further comprises a speaker which produces sound to prompt the driver when the displacement-detecting unit detects that the vehicle moves to the turning point.

4. The method for parking a vehicle by using a parking assistant system as claimed in claim 1, wherein the display unit displays a prompt which uses countdown numbers or lights that go out one by one to prompt the driver.

5. The method for parking a vehicle by using a parking assistant system as claimed in claim 1, wherein the displacement-detecting unit is a gyroscope or a speed sensor.

6. The method for parking a vehicle by using a parking assistant system as claimed in claim 1, wherein the parking assistant system includes a steering-wheel-angle detecting unit which serves to detect whether the driver turns the steering wheel as guided, when the steering-wheel-angle detecting unit detects that the driver fails to turn the steering wheel as guided by the parking assistant system, parking instruction or assistance provided by the parking assistant system is cancelled immediately.

7. The method for parking a vehicle by using a parking assistant system as claimed in claim 1, wherein a plurality of target parking frames are displayed on the display unit for the driver to choose.

8. The method for parking a vehicle by using a parking assistant system as claimed in claim 1, wherein the target parking frame is allowed to be moved on the display unit.

9. A method for parking a vehicle by using a parking assistant system, the parking assistant system comprising a lateral camera, a displacement-detecting unit, a display unit built-in with a parking-path planning software, and a CPU, the method for parking a vehicle by using the parking assistant system comprising the following steps:
turning on the parking assistant system;
the display unit displaying the images of the lateral areas of the vehicle taken by the lateral camera and also displaying a movable target parking frame and an obstacle frame, the target parking frame is allowed to be moved to a virtual parking position where the vehicle is to be parked by a driver;
using the CPU to calculate a virtual parking path based on the virtual parking position and a specification of the vehicle, and the virtual parking path including a turning point and an end point;
the driver presses down the start key after driving the vehicle to a position where the obstacle is overlapped with wheels of an adjacent vehicle, then the display unit starts to instruct the driver to reverse the vehicle by turning the steering wheel toward the parking space, and the steering wheel is turned to the extreme;
the displacement-detecting unit detecting an actual path that the vehicle travels and comparing it with the optimum virtual parking path, when the vehicle moves along to the turning point of the virtual parking path, the display unit instructs the driver to turn the steering wheel reversely to the extreme in a direction opposite the direction of the parking space and the driver continues reversing the vehicle; and
the displacement-detecting unit continues detecting the actual path that the vehicle travels and comparing it with the virtual parking path, when the vehicle moves to the end point of the virtual parking path, the parking assistance parking assistant system is turned off.

10. The method for parking a vehicle by using a parking assistant system as claimed in claim 9, wherein the driver is reminded that the obstacle frame should not be overlapped with the wheels of the adjacent vehicle, when the driver moves the target parking frame.

11. The method for parking a vehicle by using a parking assistant system as claimed in claim 9, wherein a plurality of target parking frames are displayed on the display unit for the driver to choose.

12. The method for parking a vehicle by using a parking assistant system as claimed in claim 9, wherein the target parking frame is allowed to be moved on the display unit.

13. The method for parking a vehicle by using a parking assistant system as claimed in claim 9, wherein the displacement-detecting unit detects whether the driver moves the vehicle as guided by the parking assistant system, if the displacement-detecting unit detects that the driver fails to drive the vehicle as guided by the parking assistant system, the parking assistant system will be turned off, and parking instruction provided by the parking assistant system will be cancelled immediately.

14. The method for parking a vehicle by using a parking assistant system as claimed in claim 9, wherein the parking assistant system further comprises a speaker which produces sound to prompt the driver when the displacement-detecting unit detects that the vehicle moves to the turning point.

15. The method for parking a vehicle by using a parking assistant system as claimed in claim 9, wherein the display unit displays a prompt which uses countdown numbers or lights that go out one by one to prompt the driver.

16. The method for parking a vehicle by using a parking assistant system as claimed in claim 9, wherein the displacement-detecting unit is a gyroscope or a speed sensor.

17. The method for parking a vehicle by using a parking assistant system as claimed in claim 9, wherein the parking assistant system includes a steering-wheel-angle detecting unit which serves to detect whether the driver turns the steering wheel as guided, when the steering-wheel-angle detecting unit detects that the driver fails to turn the steering wheel as guided by the parking assistant system, parking instruction or assistance provided by the parking assistant system is cancelled immediately.

18. A method for parking a vehicle by using a parking assistant system, the parking assistant system comprising: a lateral camera, a displacement-detecting unit, a display unit, a distance-detecting unit, and a CPU built-in with a parking-path planning software, the method for parking a vehicle by using the parking assistant system comprising the following steps:
turning on the parking assistant system;
using the display unit to display the images of the lateral areas of the vehicle taken by the lateral camera, and the distance-detecting unit calculating a distance from the vehicle to an adjacent vehicle;
using the CPU to calculate a virtual parking path based on the distance from the vehicle to the adjacent vehicle calculated by the distance-detecting unit, and a specification of the vehicle, and the virtual parking path including an obstacle frame, a turning point and an end point, and the obstacle frame being displayed on the display unit;
the driver presses down the start key after driving the vehicle to a position where the obstacle is overlapped with wheels of an adjacent vehicle, then the display unit starts to instruct the driver to reverse the vehicle by turning the steering wheel toward the parking space, and the steering wheel is turned to the extreme;
the displacement-detecting unit detecting an actual path that the vehicle travels and comparing it with the optimum virtual parking path, when the vehicle moves along to the turning point of the virtual parking path, the display unit instructs the driver to turn the steering wheel reversely to the extreme in a direction opposite the direction of the parking space and the driver continues reversing the vehicle; and
the displacement-detecting unit continues detecting the actual path that the vehicle travels and comparing it with the virtual parking path, when the vehicle moves to the end point of the virtual parking path, the parking assistance parking assistant system is turned off.

19. The method for parking a vehicle by using a parking assistant system as claimed in claim 18, wherein the display unit is further capable of simultaneously displaying a movable target parking frame which can be moved to a virtual parking position where the vehicle is to be parked by the driver, the CPU calculates a virtual parking path based on the virtual parking position selected by the target parking frame and the specification of the vehicle.

20. The method for parking a vehicle by using a parking assistant system as claimed in claim 19, wherein the driver is reminded that the obstacle frame should not be overlapped with the wheels of the adjacent vehicle, when the driver moves the target parking frame.

21. The method for parking a vehicle by using a parking assistant system as claimed in claim 19, wherein the target parking frame is allowed to be moved on the display unit.

22. The method for parking a vehicle by using a parking assistant system as claimed in claim 19, wherein a plurality of target parking frames are displayed on the display unit for the driver to choose.

23. The method for parking a vehicle by using a parking assistant system as claimed in claim 18 wherein the displacement-detecting unit detects whether the driver moves the vehicle as guided by the parking assistant system, if the displacement-detecting unit detects that the driver fails to drive the vehicle as guided by the parking assistant system, the parking assistant system will be turned off, and parking instruction provided by the parking assistant system will be cancelled immediately.

24. The method for parking a vehicle by using a parking assistant system as claimed in claim 18, wherein the parking assistant system further comprises a speaker which produces sound to prompt the driver when the displacement-detecting unit detects that the vehicle moves to the turning point.

25. The method for parking a vehicle by using a parking assistant system as claimed in claim 18, wherein the display unit displays a prompt which uses countdown numbers or lights that go out one by one to prompt the driver.

26. The method for parking a vehicle by using a parking assistant system as claimed in claim 18, wherein the displacement-detecting unit is a gyroscope or a speed sensor.

27. The method for parking a vehicle by using a parking assistant system as claimed in claim 18, wherein the parking assistant system includes a steering-wheel-angle detecting unit which serves to detect whether the driver turns the steering wheel as guided, when the steering-wheel-angle detecting unit detects that the driver fails to turn the steering wheel as guided by the parking assistant system, parking instruction or assistance provided by the parking assistant system is cancelled immediately.
